(19) United States
(12) Patent Application Publication
(10) Pub. No.: US 2013/0215261 A1
(43) Pub. Date: Aug. 22, 2013

(54) Method For Detecting Defects In Glassware Articles, And Installation For Implementing Said Method

(71) Applicants: Majd Rahmani, Villeurbanne (FR); Christophe Deloly, Charly (FR); Philippe Volay, Saint Genis Les Ollieres (FR)

(72) Inventors: Majd Rahmani, Villeurbanne (FR); Christophe Deloly, Charly (FR); Philippe Volay, Saint Genis Les Ollieres (FR)

(21) Appl. No.: 13/651,021

(22) Filed: Oct. 12, 2012

Related U.S. Application Data
(63) Continuation of application No. PCT/FR2011/050837, filed on Apr. 12, 2011.

(30) Foreign Application Priority Data
Apr. 13, 2010 (FR) 1052824

(51) Int. Cl. H04N 9/04; H04N 7/18

(52) U.S. Cl. CPC H04N 9/04; H04N 7/18
USPC 348/93; 348/92

(57) ABSTRACT

A method for detecting low-contrast pressing or blowing defects in glassware articles includes the steps of backlighting the article by way of one or several light sources according to at least one pair of similar patterns shifted in space; capturing at least one pair of images of the backlit article according to each of the patterns of the at least one pair of patterns; combining the images of each of the pairs to form at least one composite image; and detecting the areas of stronger contrast within the composite images.

### FIELD OF THE INVENTION

The present disclosure relates to installations for controlling the manufacturing quality of glassware articles such as bottles, flasks, and other containers. It more specifically aims at a method specifically dedicated to the detection of a certain type of so-called “transparent” defects, as opposed to so-called “opaque” defects, which are easily detectable.

### BACKGROUND OF THE INVENTION

Term “transparent” defects especially but not exclusively designates defects formed by bubbles present at the surface of the article, which have a very small thickness, so that their backlighting generates areas of very low contrast, and thus difficult to detect. Such defects are particularly critical for the use of articles in industries such as perfumery where the requirements in terms of regularity of appearance are very high. The pharmaceutical industry is also very sensitive, since this type of defects may result in the forming of glass splinters, which are all the more dangerous as they are inside of the flask.

Other “transparent” defects, such as inverted or non-inverted pleats, are also difficult to detect, although they are more easily apparent when the article is full.

Generally, transparent defects are quite difficult to detect, and many solutions have already been provided.

Thus, a first technique comprises backlighting an article with a “pattern” formed of different parallel light strips instead of using a homogeneous light source. A structured light is thus generated, which acts on the article like a plurality of separate sources, thereby slightly increasing the contrast of the defects thus backlit. This type of method is however not really satisfactory, since the areas located in front of the masked portions of the pattern are not really inspected. Further, small defects are not easily detectable, since they must have a size greater than the pattern step so that their contrast increases in the obtained image. Moreover, the images thus obtained are difficult to analyze for articles with deformations due to an inhomogeneous thickness distribution. In other words, this method is more specifically intended for flat objects, or more generally, for objects of constant thickness.

To form strip patterns of this type, different technical solutions have been provided, which comprise using semi-transparent masks interposed in front of a light source, or again sources formed from rows of light-emitting diodes which may be illuminated by creating series of light strips. Although this last solution enables to adapt to different types of articles by reprogramming the geometry of the illuminated strips, it is however not fully satisfactory regarding the mentioned disadvantages, in particular the defect size, and articles of non-constant thickness.

An example of installation implementing an illumination using a pattern is described in document EP 931 973. This type of installation compares images of an object illuminated via a pattern, and an image of the pattern alone, to deduce the presence of possible defects. However, this comparison does not enable to detect the defects present in the dark areas of the pattern.

### SUMMARY OF THE INVENTION

The present invention thus relates to a method for detecting pressing or blowing defects in glassware articles, and more specifically so-called transparent defects, that is, defects which appear with a light contrast when backlit

According to the present invention, this method first comprises backlighting the concerned article by means of one or several light sources, and this, according to at least one pair of similar lighting patterns, shifted in space. Then, at least one pair of images of this backlit article is captured according to the same angle of sight, each image of the pair corresponding to one of the patterns of the above-mentioned pair of patterns. Then, the two images of each of the pairs are combined to form at least one composite image. Finally, areas of stronger contrast can thus be detected within such composite images.

In other words, the present invention comprises backlighting a transparent object according to two lighting patterns which are different, but which can be geometrically deduced from each other, so that the two images thus obtained can be assembled by a processing which enables to highlight possible defects. Indeed, the two individual images obtained from the lighting of each of the patterns of the characteristic pair have local illuminated areas in regions which can be geometrically deduced from the space shift of the illuminated areas of the patterns. The cameras have confounded optical axes, so that they capture images corresponding to the same scene. Such images only differ because of the lighting pattern differences, and can thus superpose.

In other words, the illuminated regions of each of the patterns generate local illuminated regions on each image, where the disturbance generated by the possible defects to be identified causes some type of distortions. Such distortions are not perfectly superposed according to the illumination of the two patterns, so that the combination of the characteristic images can highlight with a particular contrast the defect area in this composite image.

In practice, different geometries may be adopted for the patterns, and in particular patterns comprising sets of parallel strips, such strips being shifted in space by one half-step from one pattern to the other.

Advantageously, the ratio of the width of strip to the pattern step ranges between 5 and 40%.

It has indeed been noted that when the strips take up less than the width of a half-step, overlappings between areas illuminated by the strips from one pattern to the other are minimized or even suppressed, whereby disturbances due to defects can thus be more easily detected. The ratio of the strip width to the pattern step may be regulated and optimized according to the type of glassware article to be analyzed, and especially according to the general size of the article, but also to the size of the specific areas to be analyzed.

In practice, it may be advantageous to use a single light source, which generates the illumination of the two patterns according to different colors, to be then separated by a filtering adapted to each of these colors. Thus, a same source may be arranged to illuminate according to patterns of strips of two colors, shifted in space and separated by black areas thus corresponding to the common areas of the two patterns,

In practice, this analysis may be combined by backlighting the article according to several pairs of patterns, each pair having a different direction. Thus, in the specific case of parallel strips, a pair of patterns may have a direction perpendicular to that of the second pair, to improve detection performances. Of course, this principle may be developed by multiplying the number of pairs of patterns according to the degree of accuracy which is desired to be obtained.

In practice, different operations may be performed to combine the two images of a same pair. A possible combination is to determine the minimum intensity of each pixel of the two images to thus obtain a composite image. Different pre-. (or post-) processing operations may be carried out to improve the detection efficiency, or to ease the composite image processing for the detection of defects.

It is thus for example possible to perform a color level correction on each of the two images of an illumination pair before combining them. An adaptive thresholding may in a number of cases be an adequate post-processing.

The present invention may thus be implemented on an installation which comprises:
at least one light source capable of providing light according to a pair of similar patterns shifted in space;
at least one camera arranged on the side opposite to the article with respect to the light sources, this or these camera(s) being capable of generating several images of the backlit article, each according to one of the patterns of the pair of lighting patterns;
means for combining the images captured by the camera(s) to form a composite image and for displaying or processing this composite image to detect therein the areas of higher contrast generally corresponding to the defect areas searched for,

In practice, this installation may advantageously comprise a single light source, which is capable of providing light according to the pair of patterns. Thus, in the case of a strip illumination according to two different colors, the source generates the double series of strips shifted by one half-step.

In practice, the installation may comprise several cameras capable of each generating an image corresponding to the illumination by one of the patterns, the cameras being arranged to capture the same scene. It is also possible for the installation to comprise a single camera with several sensors, or even a single sensor sensitive over a spectrum extending over the wavelengths of the different illumination patterns, such as for example a “TriCCD”-type sensor.

In the case where several cameras are used, it is advantageous for the installation to comprise an image-dividing device, arranged to convey the image of the backlit article to each of the cameras, so that the cameras receive simultaneous images, strictly under the same incidence.

Advantageously, each of these images is filtered according to the color of the strips of the illumination pattern, to obtain grey level images, which can be easily combined.

### BRIEF DESCRIPTION OF THE DRAWINGS

The implementation and other features and advantages of the present invention will be discussed in detail in the following non-limiting description of the following embodiment in connection with the accompanying drawings, among which:

FIG. 1 is a simplified top view of an installation according to the present invention;

FIGS. 2a and 2b are front views of the light source respectively illuminated according to the two patterns;

FIG. 2c is a view of the same light source showing the simultaneous illumination according to the two patterns;

FIGS. 3a and 3b are images of a first article respectively illuminated according to two patterns;

FIG. 4 is an image showing the combination of the t o images of FIGS. 3a and 3b;

FIGS. 5a and 5b are images similar to FIGS. 3a and 3b for a second glassware article;

FIG. 6 is a composite image combining the two images of FIGS. 5a and 5b.

### DETAILED DESCRIPTION OF THE INVENTION

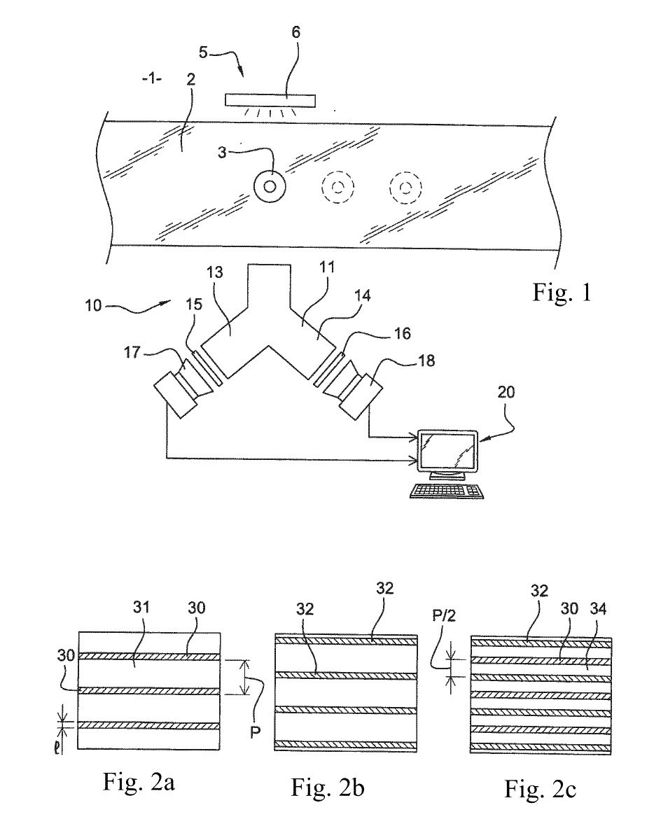

As already mentioned, the present invention relates to a method and an installation for detecting so-called transparent defects 1 in glassware articles. An example of such an installation is shown in FIG. 1, which shows a conveyor 2 having the different articles 3 to be analyzed deposited thereon, and which thus pass in front of defect detection station 5. In the illustrated form, the installation comprises an analysis station 5, essentially formed of a light source 6 located on one side of conveyor 2, and of an image capture assembly 10 located on the opposite side. Of course, the present invention also encompasses variations where the analysis station comprises several couples of light sources/image capture assembly, enabling to analyze a same article according to several angles of incidence. The present invention also encompasses variations for which the line of sight of the cameras forms a non-zero angle with the direction perpendicular to the light source. The different angles providing efficient results on the tested articles range between 0° and 60°. This angle may be in a horizontal plane, that is, parallel to the conveyor conveying the articles, to inspect a portion of the front and rear surfaces of the articles, according to its displacement direction. This angle may also be in a vertical plane, to make it possible to inspect high and low portions, such as for example, the shoulder area of a bottle.

In the embodiment illustrated in FIG. 1, light source 6 is schematically shown and may be formed in different ways, such as for example by a liquid crystal display (LCD) or more generally by an array of different light-emitting diodes. It may also be a source formed of a projector combined with superposed patterns enabling to define the pair of characteristic patterns. An alternative solution may be achieved with a source based on light-emitting diodes.

On the other side of conveyor 2, image capture assembly 10 is mainly formed of a device 11 enabling to generate two identical images from a single image capture. This “image dividing” device may for example be of “CCD Multiplier” type, sold under reference “S5 SET 1035” by SILL OPTICS GmbH.

In the illustrated case where the illumination patterns are formed with a chromatic discrimination, the two outputs 13, 14 of the image divider are interfaced with a color filter 15, 16 enabling to only keep the information resulting from one of the color patterns. In a variation, not shown, it is also possible to use a single camera having a TriCCD-type sensor, sensitive over a spectrum comprising the colors of the two patterns.

Image divider 11 thus powers two cameras 17, 18 corresponding to models conventionally used in the detection of glassware article defects, such as for example monochromatic cameras based on CCD sensors sold by JAI A. S under reference CVA1. These two cameras 17, 18 are interfaced with a control unit 20, capable of carrying out several image processings, and in particular the combination of two images originating from each of the cameras. Due to the presence of the image divider, the two cameras capture the same scene, and have the same optical axis in the useful areas containing the article to be inspected.

As illustrated in FIGS. 2a, 2b, the characteristic patterns may appear in the form of parallel color strips 30, separated by black strips 31 or more specifically strips causing no illumination. Illuminated strips 30 are regularly distributed with a step (p) corresponding to the distance separating the middle of two adjacent strips 30. The pattern illustrated in FIG. 2b is also formed of a succession of parallel strips 32, distributed with the same step (p). In the case of a chromatic-type discrimination, illuminated strips 32 of the second pattern have a wavelength different from that of the color of strips 30 of the first pattern illustrated in FIG. 2a.

Preferably, colors having distant wavelengths, such as blue and red, will be selected, it being understood that the discrimination will be all the more efficient as the light spectrums of the sources will have the tightest possible lines.

According to the present invention, strips 32 of the second are shifted in space from those 30 of the first pattern, advantageously by one half-step. Thus, as illustrated in FIG. 2c, the superposition of the two pa terns corresponds, at the light source, to a double succession of alternated color strips. In the embodiment illustrated in FIG. 2c, it should be noted that light strips 30, 32 do not overlap, and are thus separated by black strips 34. In other words, the ratio of the width (l) of a light strip to step p is smaller than 50%, and may be set according to the type of article to be analyzed. More specifically, the more the strips are deformed through the article due to a complex three-dimensional geometry, the more advantageous it is to decrease this ratio, down to a limit on the order of 5%. Conversely, the higher this ratio, that is, as it approaches approximately 40%, the lighter the contrast of the defects to be detected, which makes them more difficult to detect. A compromise should be reached within this range from 5 to 45%. Thus, tests have shown that the detection of pleats and bubbles is better when the ratio is respectively around 10% and 25%.

Of course, the present invention also encompasses variations where the patterns are not formed of parallel rectilinear strips, but combine other geometries of various types, provided that there is no overlapping between two patterns when superposed. Similarly, FIGS. 2a to 2c have been shown with parallel light strips of same width from one pattern to the other, without for this to be absolutely compulsory.

The same principle illustrated for two patterns may of course be developed with a larger number of patterns, by means of additional series of parallel light strips, taking different colors.

Similarly, it is possible to combine other complementary patterns, for example, parallel light strips which are not parallel from one pattern to the other. It can thus be envisaged to superpose two pairs of patterns created from the same source, a first pair taking a first inclination and the second pair taking a perpendicular inclination. Four different filterings are then used at the level of the image divider, which should thus generate four distinct images, each adapted to a specific color filter, The image acquisition should be simultaneous for the two images of a pair of patterns, but the two pairs may be acquired simultaneously or successively in time.

Within electronic control unit 20, the two filtered images obtained at the output of cameras 17 arranged on image divider 11 are combined. Different types of combinations may be envisaged, such as in particular, for each pixel, the selection of the minimum intensity of the two elementary images.

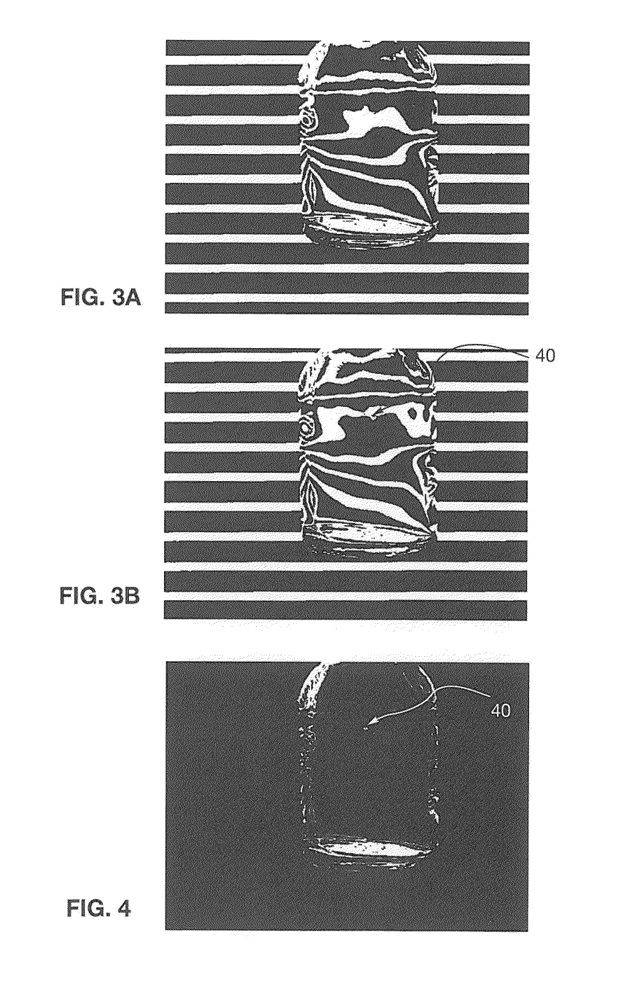

Different examples are illustrated in FIGS. 3a, 3b, and 4. FIG. 3a shows an image of an article illuminated according to a first pattern, where the transparent defect is almost undetectable. FIG. 3b also is an image taken according to the second illumination pattern where defect 40 is difficult to identify. The combination of the two images, after a pre-processing such as an adaptive thresholding combined with a recognition of elongated and horizontal shapes, provides the image illustrated in FIG. 4, where a light spot 40 clearly appears at the center of the article, in the middle of the totally dark area formed by the center of the article. This light spot corresponds to the detection of a skin blister.

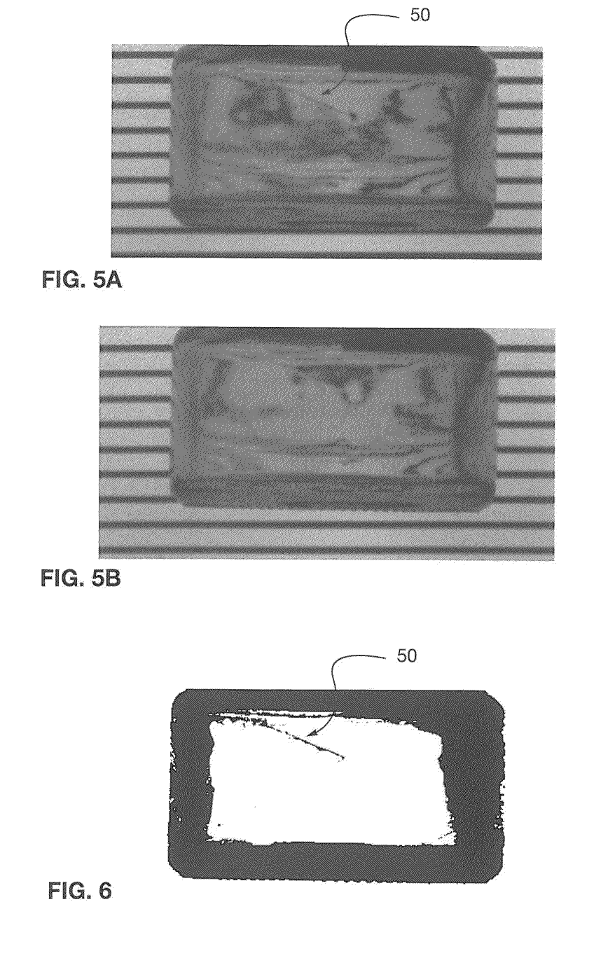

Similarly, FIGS. 5a and 5b are two images of a same article according to the two illumination patterns. A dark line 50 can be detected inside of the article, and is visible in FIG. 5a, but it is directly connected with other light areas, so that it is difficult to identify it as a defect. It should be noted that this dark line is invisible in FIG. 5b.

The combination of the two images of FIGS. 5a and 5b provides the composite image of FIG. 6. In this case, since the illumination patterns have a light, and more specifically white, tinge, the two images are combined by keeping the maximum value for each pixel. In this case, inclined dark line 50 located approximately at the center of the article and in the upper portion of the central area is very clearly apparent, and thus enables to detect a pleat-type defect.

As appears from the foregoing, the installation and the method of the present invention advantageously enable to detect transparent defects with a much higher success rate than prior art solutions, and this, by using materials of standard design, with analysis rates compatible with the maximum current production rates, that is, on the order of 600 articles per minute.

1. A method for detecting pressing or blowing defects in a glassware article comprising the steps of:
backlighting said article by way of one or several light sources according to at least one pair of similar patterns shifted in space;
capturing according to the same angle of sight at least one pair of images of said backlit article according to each of the patterns of said at least one pair of patterns;
combining the images of each of said pairs to form at least one composite image;
detecting the areas of stronger contrast within said composite images.

2. The detection method of claim 1, characterized in that the patterns are sets of parallel strips shifted in space by one half-step from one pattern to the other.

3. The detection method of claim 2, characterized in that the patterns are sets of strips of two different colors.

4. The detection method of claim 2, characterized in that ratio of the width of a strip to the step of the pattern ranges between 5 and 40%.

5. The detection method of claim 2, characterized in that the article is backlit according to several pairs of patterns, each pair having a different direction.

6. The detection method of claim 2, characterized in that the combination of the images of a pair comprises a processing similar to the determination of the minimum intensity of each pixel of the two images.

7. An installation for detecting low-contrast defects in a glassware article, comprising:
at least one light source capable of providing light according to a pair of similar patterns shifted in space;
at least one camera arranged on a side opposite to the article with respect to said at least one light source, said at least one camera being capable of generating a pair of images of said article backlit by said at least one source according to each pattern of the pair of patterns;
means for combining said images of the pair in a composite image and for displaying or processing said composite image to detect areas of stronger contrast.

8. The installation of claim 7, characterized in that said installation comprises a single light source capable of providing light according to the pair of patterns.

9. The installation of claim 7, characterized in that said installation comprises a plurality of cameras capable of capturing the same scene.

10. The installation of claim 9, characterized in that said installation comprises an image-dividing device arranged to convey the image of the backlit article to each of the cameras.

11. The installation of claim 7, characterized in that each of the images is filtered according to a color of strips of said pattern, to obtain grey level images.
